(19) United States
(12) Patent Application Publication
(10) Pub. No.: US 2008/0282601 A1
(43) Pub. Date: Nov. 20, 2008

(54) Hardened Vegetable Oils and Derivatives Thereof

(76) Inventor: Jens Luttke, Hamburg (DE)

Correspondence Address: FISH & RICHARDSON P.C., PO BOX 1022, MINNEAPOLIS, MN, 55440-1022, US

(21) Appl. No.: 11/816,783

(22) PCT Filed: Feb. 21, 2006
(86) PCT No.: PCT/EP2006/001553

§ 371 Date: Jul. 3, 2008

(30) Foreign Application Priority Data
Feb. 21, 2005 (DE) 05003673.0

(51) Int. Cl. C11C 5/00

(52) U.S. Cl. 44/275

(57) ABSTRACT

The present invention concerns a fully hardened or partially hardened triglyceride vegetable oil composition and derivatives thereof comprising inter alia fatty acids, mono-glycerides, di-glycerides and so forth. These compositions may comprise triglyceride oils or derivatives thereof with a content of various tocopherols not exceeding a level of 20 ppm. The products according to the present invention show less colour development or colour reversion with time, in particular upon exposure to heat and/or air.

Fully hardened or partially hardened triglyceride vegetable oil compositions and derivatives thereof comprising inter alia fatty acids, mono-glycerides, di-glycerides and so forth. These compositions typically comprise triglyceride oils or derivatives thereof (i. a. fatty acids, mono-glycerides, di-glycerides) with a content of various tocopherols not exceeding a level of 20 ppm.

### BACKGROUND OF THE INVENTION

Low coloured fats (and the derivatives thereof) are widely used in various industries in order to manufacture products that are utilized in either transparent applications, such as acrylic glass, plastic foils, or nearly colourless applications such as transparent soaps or detergents. Moreover, the colour stability of fat derived products is of importance in numerous applications such as gels, adhesives, primers, plastics, plasticizers and many other applications.

In order to meet the needs of the industry, as of today, extensive use is made of animal fats, such as lard or tallow. Fully or partially hydrogenated animal fats have a whitish colour and when melted seem to be practically colourless (almost like water). In addition, these fats may show very little tendency to darken over time, especially when exposed to oxygen and are, therefore, particularly useful in applications requiring products to have little or no colour.

Vegetable fats, while often cheaper and more widely available, however, have not been considered for such applications since their colour stability performs poorly in these challenging applications. Vegetable derived fats often contain various amounts of minor compounds such as tocopherols, chlorophylls, caroteens, vitamins, sterols and sterol esters which have a complex affect on the suitability of the fat in various applications. Such minor components (other than cholesterols) are typically not present in significant amounts in animal fats. Thus, animal fats were typically the first choice for applications where colour and/or colour stability was a concern.

A vegetable oil composition typically is produced in several steps. Seeds (such as soybean seeds) may be cleaned, tempered, dehulled, and flaked to prepare the seeds for an efficient oil extraction. Oil extraction is usually accomplished by solvent extraction or by a combination of physical pressure and/or solvent extraction. The resulting oil is called crude oil. The crude oil may be degummed by hydrating phospholipids and other polar and neutral lipid complexes which facilitate their separation from the non-hydrating, triglyceride fraction. The degummed oil may be further refined for the removal of impurities, primarily free fatty acids, pigments, and residual gums. Refining is accomplished by the addition of caustic which reacts with free fatty acids to form soap and hydrates phosphatides and proteins in the crude oil.

Water is used to wash out traces of soap formed during refining. Colour typically will be removed through absorption with a bleaching earth which removes most of the chlorophyll and carotenoid compounds. The refined oil may then be hydrogenated either fully or partially to produce fats with various melting properties and textures. Additionally, oils and fats may be further processed through deodorization which is principally a steam distillation under vacuum. Deodorization is designed to remove volatile, polar compounds which can affect the flavour, odor and quality of the product. Typically, the levels of impurities such as tocopherols and sterols are lowered during the deodorization process.

Hydrogenation is a chemical reaction in which hydrogen is added to the unsaturated fatty acid double bonds of an oil with the aid of a catalyst such as nickel. Hydrogenation has two primary effects. First, the oxidative stability of the oil is increased as a result of reduction in the unsaturated fatty acid content. Second, the physical properties of the oil are changed because the fatty acid modifications increase the product's melting point resulting in a semi-liquid or solid fat at room temperature.

Selective hydrogenation conditions can be used to hydrogenate the more unsaturated fatty acids in preference to the less unsaturated ones. Very light or brush hydrogenation is often employed to increase stability of liquid oil. Further, hydrogenation converts a liquid oil to a physically solid fat. The degree of hydrogenation depends on the desired performance and melting characteristics desired for the particular end-product.

The particular vegetable oils addressed by the present invention include hydrogenated triglyceride oils such as palm kernel oil, palm oil, palm oleins, palm stearines, palm mid fractions, olive oil, rapeseed oil, canola oil, linseed oil, ground nut oil, soybean oil, cotton seed oil, sunflower seed oil, pumpkin seed oil, coconut oil, corn oil, castor oil, walnut oil, haselnut oil, safflower oil, false flax oil and mixtures thereof. The iodine values of the hydrogenated triglyceride oils for use in the instant invention may be determined by methods commonly known and used in the industry, such as the AOCS Cd 1-25 method (revised 1992). Hydrogenated triglyceride oils of the present invention typically have an iodine value below 10 g/100 g, preferably below 5 g/100 g, and more preferably below 2 g/100 g. Such hardened oils will typically have a melting point of above 30° C.

Although these oils would be considered significantly stabilized in accordance with conventional wisdom in the art of oil stabilization, it was observed that upon exposure to oxygen (or air), in particular in the presence of heat, the traditional products readily develop significant colour (colour reversion).

The problem addressed by the present invention relates both to the colour and possible colour reversion of hardened oil compositions useful in the production of a wide variety of products requiring little or no colour. Typically, a change of the colour of a triglyceride oil composition is related to the lack of stability of said composition. Thus, the main focus is on the stability of oil compositions. Accordingly, the generally accepted understanding in the oil industry is that whenever problems of stability are properly solved, colour stability of the product should not be an issue. Prior to the present invention there existed no solution to yield compositions of hardened vegetable oils which could be utilized in the production of products requiring little or no colour or colour reversion.

The prior art is aware of several methods to increase the stability of vegetable oil. One commonly used method is catalytic hydrogenation, a process that reduces the number of double bonds and raises the melting point of the fat. Consequently, hydrogenation also increases the saturated fatty acid content. This approach has been implemented thus far but did not overcome the colouring problem in hydrogenated vegetable oils; especially in storage. Another well known approach is to increase the oxidative stability by addition of antioxidants. However, this approach (adding of further components) would be counter productive when it comes to vegetable oils since overall the amount of impurities or by-products should be diminished. The prior art suggests that the addition of tocopherol to triglyceride oils may positively influence the stability. This approach would create further problems that will become clearer from the following discussion of the discovery underlying the present invention.

U.S. Pat. No. 4,789,554 suggests to improve the frylife of edible oil through a vacuum steam stripping at very high temperatures for short residence times. This vacuum steam stripping would remove some compounds such as tocopherols, tocotrienols, sterols, cholesterol, trace pesticides, and quinone-type structures which are believed to be deleterious to frylife of edible oil. However, the applied stripping method may not have removed tocopherols to an overall level of less than 100 ppm. Although the aim is to achieve a relatively high “stripping factor” the typical stripping time should be in the range of about 60 seconds at high temperatures. The authors of this patent observed that with longer stripping times the stripping factor may be increased but an unacceptable product would be obtained (in terms of unacceptably high levels of high molecular weight materials (i.e. polymers of triglyceride)). Second, a significant reduction of the tocopherols to the levels envisaged by the present invention would have led to a significant reduction in oxidative stability. As of today, producers of frying oils advertise that tocopherols have to be added to such oils to improve both frylife and stability. As reported by several authors, inter alia Karl-Heinz Wagner, Ibrahim Elmadfa in Eur. J. Lipid Sci. Technol. 102 (2000) 624-629, tocopherols are necessary to maintain the stability of edible vegetable oils.

The inventor of the present invention has surprisingly discovered that the tocopherol content of fully hydrogenated vegetable oil is responsible for the colouring of the compositions once they are exposed to oxygen. He has undertaken a thorough investigation of the phenomenon and determined that in particular gamma-tocopherol shows the most significant effect in terms of colouring and/or colour reversion of a fully hardened oil when exposed to ambient air. Removal of tocopherols from oil such that extreme low levels (or almost no tocopherol) as contemplated in the present invention are achieved requires extreme distillation or stripping conditions. Such conditions generally are believed to entail the production of undesirable by-products (see supra). Accordingly, it was surprising to find that products of the current invention demonstrate advantageous properties. Moreover, several producers of vegetable oils (including Riken, Inc., Japan) recommend that tocopherols should be added to maintain flavour, colour and stability of various oil products. Unhardened vegetable oil (typically iodine value>40) contains significant amounts of tocopherol (>100-200 ppm) and, thus, can be heated in the presence of oxygen for some time without causing any colouring reaction. (Nevertheless, the colour of such oils deteriorates over time.) Hardened vegetable oil of the prior art, in spite of the presence of tocopherols, readily show some colouring upon exposure to heat and air. Accordingly, it was surprising to find that upon removal of tocopherols from such hardened oils a product can be obtained with an improved colouring behaviour.

### SUMMARY OF THE INVENTION

The present invention relates to a vegetable oil composition comprising a hardened vegetable oil wherein the hardened vegetable oil contains less than 20 ppm total tocopherol and has an iodine value of less than 10 g/100 g. The hardened oils are typically characterized by a melting point of above 10° C., especially above 30° C., preferably above 50° C., and an iodine value of less than 10 g/100 g or 5 g/100 g, preferably less than 2 g/100 g (measured for example in accordance with AOCS Cd 1-25).

The composition of the present invention typically comprises a triglyceride oil, but the present invention also provides for compositions comprising monoglycerides, diglycerides, and mixtures thereof. Monoglycerides derived from a triglyceride composition of the present invention are typically obtained by a reaction of the (fully hardened) triglyceride with glycerol utilizing processes well known and described in the art. The main reaction product is a monoglyceride and the diglyceride. However, in a secondary reaction the diglyceride may further react with glycerol thereby forming monoglyceride. The reaction is typically conducted by heating the composition to approximately 240° C., optionally in the presence of a catalyst. Alternatively, such monoglycerides, diglycerides and mixtures thereof can be obtained by reacting fatty acids—derived from the triglycerides of the present invention by hydrolysis—with glycerol under esterifying conditions. Under all these typical production conditions any monoglyceride, diglyceride or mixture thereof, prepared from a fully hardened vegetable oil, will develop a significant colour unless the tocopherol level is maintained at less than 20 ppm, preferably less than 10 ppm. Thus, as of today, it has not been possible to obtain whitish or colourless compositions of mono and diglycerides, derived from vegetable oils which would remain colour stable with time and/or exposure to heat or oxygen.

Vegetable oils can be distinguished from animal oils (including monoglycerides and diglycerides derived therefrom) by the distribution of various fatty acids comprising the triglycerides. This distribution of fatty acids, often called a fatty acid profile is characteristic of, and can identify, an oil's source. For example, animal oils (and products derived therefrom) comprise a significant amount of fatty acids with an uneven carbon number.

As elaborated above the present invention is based on the appreciation that the significant colouring (or darkening) of hardened vegetable oils is related to the presence of tocopherol in the oil. Generally, it is believed that tocopherols contribute to the stability of the vegetable oil and, thus, depleting a composition of vegetable oil of tocopherols would be counter productive. Moreover, it was observed that the formation of colour in fully hardened vegetable oils proceeds rapidly and appears to be more or less irreversible.

The term tocopherol in the context of the present invention is meant to refer to alpha-, beta-, gamma- and delta-tocopherol.

It has been found out that the colouring behaviour of the fully hardened vegetable oil composition is particularly affected by the presence of gamma-tocopherol. Thus, the composition of the present invention generally should contain less than 10 ppm gamma-tocopherol, preferably less than 3 ppm. Although it may be preferred to remove practically all tocopherol present in the composition, levels of 0.2 to 1 ppm gamma-tocopherol were found to be acceptable in terms of colouring behaviour. Thus, in general tocopherol contents of alpha-, beta- and gamma-tocopherol with a concentration of less than 20 ppm, preferably less than 10 ppm was found satisfactory. Typically, the sum of the tocopherol isomers (total tocopherol content) should be observed. Accordingly, total tocopherol contents of 1, 2, 3, 4, 5, 6, 7, 8, <10, 10, <20, or 20 ppm are understood to be within the scope of the present invention whereby these values may refer to particular isomers or a combination of all or two or three etc. of them.

Alternatively, the compositions according to the present invention may be characterized by their colour as determined in accordance with method Cc 13e-92 American Oil Chemist Society (LOVIBOND colour measurement in 5¼ inch cuvettes). Lovibond measures can alternatively be determined on a Dr. Lange LICO®300 apparatus. This instrument can measure the transmissions of all media. The instrument is recommended to perform a colorimetric characterization of transparent coloured liquids according to EN 1557. The instrument can be used with 10 mm square glass or plastic cuvettes. The measuring principle is to measure the x, y and z-transmissions of a 10 mm layered sample (x=red, y=green, z=blue sensitivity to the human eye). The sample is illuminated with a halogen lamp corresponding to standard illuminant C. The measurement results of the LICO®300 can be readily converted into Lovibond values. Thus, on the Lovibond scale a sample of a composition according to the invention (e.g. 100 g in an open glass flask) put into an oven at ambient air of 120° C. for a period of 48 h would typically not show a red value significantly above 2 (preferably below 2, more preferably below 1) or a yellow value significantly above 12 (preferably below 10, more preferably below 6).

The compositions of the present invention include a vegetable triglyceride oil, such as palm oil, palm oleins, palm stearines, palm mid fractions, olive oil, rapeseed oil, canola oil, linseed oil, ground nut oil, soybean oil, cotton seed oil, sunflower seed oil, pumpkin seed oil, corn oil, castor oil, walnut oil, haselnut oil, safflower oil, fals flax oil and mixtures thereof. Preferably, the triglyceride oil is palm oil, rapeseed oil, sunflower seed oil or soybean oil, which has been hardened to an iodine value less than 20 g/100 g. These compositions typically have a melting point of above 55° C. In addition, blends of various hardened oils mentioned above are specifically included within the scope of the present invention.

A particularly preferred embodiment of the invention is a composition comprising fully hardened palm, rape seed, sun flower or soy bean oils or mixtures thereof. Such non-lauric oils have a melting point of above 55° C. These oils moreover have a fatty acid profile which makes them particularly suitable as replacements for fully hardened animal oils, such as lard. A preferred composition comprises 40 to 60 wt. % hardened oil, or greater than 90% of a hardened oil. Alternatively, compositions of the present invention can be comprised of substantially all hardened oil.

Compositions of the present invention typically mainly consist of the hardened triclyceride or compounds derived therefrom. In any event, these compositions (and derivatives therefrom) maintain the fatty acid profile which provides the signature or fingerprint which is typical for their origin. Thus, preferably the compositions according to the present invention have the fatty acid profile of vegetable oils such as palm oil, rapeseed oil, sunflower seed oil, soybean oil, or mixtures thereof. Compositions of the present invention are further understood to include products wherein the overall content of the triglycerides, diglycerides or monoglycerides, respectively, comprises at least 30, 50 or 70 wt. %.

It is understood that another embodiment of the invention includes products derived from hardened triglyceride oils such as the mono-glycerides and the di-glycerides or surfactants/detergents. The further process steps in order to arrive at such products are well known to a skilled person and, thus, need not be explained here in greater detail. Generally, detergents can be obtained by a sequence of process steps. Thus, fatty acids are separated from the triglycerides by catalyzed hydrolysis at about 180° C. (thereby producing fatty acids and glycerol). The fatty acids can be further modified into alkaline soaps. Other detergents such as non-ionic tensides or fatty alcohol ether sulfates require that the fatty acids are hydrogenated (or reduced under catalytic conditions) to fatty alcohols. The fatty alcohols may be ethoxylated or reacted with sulfonates.

The present invention also concerns fatty acids (and esters) derived from the inventive triglyceride oils, preferably C₁₂-C₂₀ carboxylic acids. Fatty acids and fatty acid methyl esters are some of the more important oleochemicals which may be derived from the vegetable oils according to the present invention. Fatty acids are used for the production of many products such as soaps, medium chain triglycerides, polyol esters, alkanol amides, etc. The vegetable oils of the present invention can be hydrolyzed or split into their corresponding fatty acids and glycerides. Fatty acids produced from various fat splitting processes may be used crude or more often are purified into fractions or individual fatty acids by distillation and fractionation. Purified fatty acids and fractions thereof may be further converted into a wide variety of oleochemicals, such as dimer and trimer acids, di-acids, alcohols, amines, amides, and esters. Fatty acid methyl esters are increasingly replacing fatty acids as starting materials for many oleochemicals such as fatty alcohols, alkanol amides, alpha-sulfonated methyl esters, diesel oil components, etc.

Moreover, interesterification products have to be understood to be within the scope of the present invention. Interesterification refers to the exchange of the fatty acyl moiety between an ester and an acid (acidolysis), an ester and an alcohol (alcoholysis) or an ester and an ester (transesterification). Interesterification reactions are achieved using chemical or enzymatic processes. Random or directed transesterification processes rearrange the fatty acids on the triglyceride molecule without changing the fatty acid composition. The modified triglyceride structure may result in a fat with altered physical properties. Directed interesterification reactions using lipases are becoming of increasing interest for specialty products like cocoa butter substitutes. Products being commercially produced during interesterification reactions include but are not limited to shortenings, margarines, cocoa butter substitutes and structured lipids containing medium chain fatty acids.

Accordingly, the present invention also relates to the use of the composition as defined herein in the production of products derived therefrom such as the various products referred to above. All these uses typically require that the final product is not significantly coloured and does not become significantly coloured upon exposure to heat and/or air or just with time. Thus, providing these products with these characteristics which are related to the particularly low concentration of tocopherols is a significant contribution.

In summary, the compositions of the present invention can be utilized in the production of various compounds/compositions and related products including emulsifiers, fatty acids, softeners, detergents and waxes (candles). Typically, these compounds/compositions are mixtures with a fingerprint or signature which is identical with or related to the fatty acid profile of the vegetable triglyceride oils from which these compounds/compositions have been derived. It is to be understood, however, that individual compounds are also within the scope of the present invention.

Occasionally, one may find certain vegetable oils in nature which may have a tocopherol content of about 20 or 30 ppm. Such oils include coconut oil having a melting point of about 22° C. Such oils—as far as they confirm with the specification demanded by the present invention (tocopherol content of less than 20 ppm)—may be used in the production of any of the products addressed by the present invention. Although the inventor is not aware of the availability of in particular coconut oil meeting the specification of the present invention he wishes to state that such oils as such, in particular coconut oils with a melting point of about 22° C. and having a tocopherol content of below 20 ppm as far as such oil already exists in nature, are not within the scope of the claims.

The reduction of tocopherol content in the compositions according to the present invention may be achieved by various means including high temperature vacuum steam distillation processes or short path thin film vacuum distillation. Typically the distillation apparatus is held at a temperature of 180 to 350° C. within a vacuum range of 0.001 to 0.01 mbar in case of wiped film distillation or higher pressures up to 1 mbar in case of falling film distillations.

Thus, the present invention further concerns a process for the manufacture of a composition as defined above wherein the content of tocopherols is lowered to a level of less than 20 ppm, preferably less than 10 ppm or 5 ppm, more preferably less than 2 ppm by way of a distillation under vacuum. Alternatively, the composition of the present invention can be produced by lowering the content of tocopherols in the vegetable oil as such and subsequently effecting the hardening of the fat.

In particular suitable is a thin film short path distillation and an equipment as provided by UIC, Inc. Jolliet, Ill., U.S.A. (or UIC GmbH, Alzenau-Hörstein, Germany).

A particular advantage of the present invention is to provide a triglyceride oil derived from a vegetable source useful in the production of mono-glycerides. Thus, the present invention also relates to a process for the production of mono-glycerides wherein the starting material is a vegetable triglyceride fat having a content of tocopherols below 20 ppm which is reacted with an excess of glycerol at a temperature of 200° C. to 260° C. The final product consisting mainly of the mono-glyceride (above 90%) may be obtained by conducting a short path distillation at a temperature of 180° C. to 220° C. (preferably about 200° C.) under a vacuum of about 0.01 mbar to 0.04 mbar. In a typical process, first so-called low-concentrates with about 50% monoglyceride, 7% diluted glycerol and 35% diglyceride are obtained. High-concentrates with a content of monoglyceride of at least 90% will be obtained by the short path distillation, where glycerol and di-/triglyceride arise as a distillation-by-product, which are re-cycled in the process of glycerolysis. The result is typically a 90% (or above) conversion of triglyceride into monoglyceride. Implementing the present invention in the context of such process for the production of monoglyceride is particularly advantageous. Since by-products are recycled in the process of glycerolysis, it is particularly advantageous to have starting or intermediate compositions with a tocopherol content of less than 20 ppm in order to obtain a final product meeting the specification of low colour/colour reversion.

In other words, the present invention makes available mono- and/or di-glycerides which have the fatty acid profile of non-lauric oil, such as palm oil, rapeseed oil, sunflower oil or soy bean oil, and with the low colour/colour reversion specification achieved by the present invention.

The present invention places emphasis on by-products that are naturally occurring in vegetable oils. These by-products in the natural oil (triglyceride or mixture of triglycerides) can be oxidized and form coloured molecules of a chinoid type. Thus, it is believed that the oxidation of tocopherols and tocotrienols may cause a pronounced darkening of fully hardened vegetable oils and fats. The compound having the major effect on darkening is the gamma-tocopherol and its oxidation products. It has been observed that as soon as a significant colour is produced in a composition comprising vegetable oils this colour cannot be removed easily by using a distillation process. Therefore, it would be advantageous to remove the tocopherol impurities as early in the process as possible to avoid the oxidation products which ultimately lead to colouration. Thus, other than the above-mentioned tocopherols (alpha, beta, gamma, delta) the composition of the present invention presumably has a low content of oxidation products, such as inter alia 5-gamma-tocopheroxy-gamma tocopherol (one may contemplate preferably less than 10 ppm, more preferably less than 5 ppm).

### EXAMPLES

Various traditionally prepared fully hardened oil samples (palm oil, rapeseed oil, stearin oil) were prepared and tested for tocopherol content. (Initial total values: 449 ppm, 406 ppm, 188 ppm) The samples were then distilled in a short path thin film distillation column. The product was analyzed with regard to the tocopherol content. The gamma-tocopherol content of all samples was below 2 ppm, other tocopherols were not detectable (determined by HPLC). Thereafter, the oil was put into an oven at a temperature of 120° C. for about 68 hours. None of the samples show a significant colouring after 68 hours. In comparison, a sample of a fully hardened rapeseed oil which was not exposed to the short path thin film vacuum distillation showed a significant colouring.

A further comparison was made by comparing a fully hardened lard (which typically contains no tocopherol) with some addition of gamma-tocopherol (500 ppm). (Standard for HPLC Analysis Supelco USA purity>99%) After only 24 hours in the oven the fully hardened lard without added tocopherol was still relatively colourless. However, the sample with added gamma-tocopherol showed a significant colouring already after 24 hours.

The color reversion of a sample comprising fully hardened palm oil having a tocopherol content of less than 10 ppm (invention) was compared with that of a sample comprising fully hardened palm oil having the natural tocopherol content. Both oils had an iodine value of below 2 g/100 g. The samples were heat treated at ambient air. It was observed that the sample according to the invention had a low color reversion whereas the sample with a tocopherol content above the limits of the present invention exhibited a pronounced color reversion with time.

1. A vegetable oil composition comprising a hardened vegetable oil, wherein the hardened vegetable oil contains less than 20 ppm total tocopherol and has an iodine value of less than 10 g/100 g.

2. The composition of claim 1, wherein the hardened vegetable oil contains less than 10 ppm total tocopherol and has an iodine value of less than 2 g/100 g.

3. The composition according to claim 1 comprising greater than 40% by weight hardened vegetable oil.

4. The composition according to claim 1, wherein the hardened oil is derived from palm nut oil, palm oil, palm oil oleins, palm oil stearines, palm oil mid fractions, olive oil, rapeseed oil, canola oil, linseed oil, ground nut oil, soybean oil, cotton seed oil, sunflower seed oil, pumpkin seed oil, coconut oil, corn oil, castor oil, walnut oil, haselnut oil, safflower oil, false flax oil and mixture/s thereof.

5. The composition of claim 4, wherein the vegetable oil is selected from the group consisting of palm oil, rapeseed oil, sunflower seed oil, soybean oil and mixture/s thereof.

6. A composition according to claim 1, wherein the hardened oil is a triglyceride, diglyceride, monoglyceride or mixture thereof.

7. The composition according to claim 6, wherein the hardened oil is a monoglyceride.

8-9. (canceled)

10. A monoglyceride, diglyceride, fatty acid, fatty acid ester, fatty acid salt, wax, or detergent comprising the composition according to claim 1.

11. The monoglyceride, diglyceride or mixture thereof according to claim 10 obtained by reacting the composition according to claim 1 with glycerol.

12. Fatty acid or fatty acid ester composition made by hydrolyzing and/or interesterifying the composition according to claim 1.

13. (canceled)

14. A candle produced from the composition according to claim 1, the wax of claim 10, or the composition of claim 12.

15. A process for the manufacture of the composition according to claim 1, wherein a hardened triglyceride oil is depleted of its tocopherol content by vacuum distillation.

16. A process for the manufacture of the composition according to claim 1, wherein a vegetable triglyceride oil is depleted of its tocopherol content and subsequently hydrogenated.
